(19) United States
(12) Patent Application Publication
(10) Pub. No.: US 2016/0004330 A1
(43) Pub. Date: Jan. 7, 2016

(54) HANDHELD MEDICAL IMAGING APPARATUS WITH CURSOR POINTER CONTROL

(71) Applicant: GENERAL ELECTRIC COMPANY, Schenectady, NY (US)

(72) Inventors: Subin SUNDARAN BABY SAROJAM, Doha (QA); Mohan KRISHNA KOMMU, Bangalore, Karnataka (IN)

(73) Assignee: GENERAL ELECTRIC COMPANY, Schenectady, NY (US)

(21) Appl. No.: 14/771,211

(22) PCT Filed: Feb. 27, 2014
(86) PCT No.: PCT/US14/19047

§ 371 Date: Aug. 28, 2015

(30) Foreign Application Priority Data
Feb. 28, 2013 (IN) 888/CHE/2013

(51) Int. Cl. G06F 3/038; G06F 3/0354; H04N 5/232; G06F 3/01; G06F 3/041; H04N 5/225

(52) U.S. Cl. CPC G06F 3/038; G06F 3/0416; H04N 5/2252; H04N 5/23293; G06F 3/017; G06F 3/03545; G06F 3/03547

(57) ABSTRACT

A handheld ultrasound imaging apparatus for capturing images of a subject is disclosed. The handheld ultrasound imaging apparatus includes a display for displaying a diagnostic ultrasound image and a plurality of user interface (UI) objects. A housing for holding the display. Further a user input interface is configured in at least one of the display and the housing. The user input interface is operable by a user to control a pointer for providing user input at points on the display to perform one or more activities.

### TECHNICAL FIELD

Embodiments of the present invention relate to a handheld medical imaging apparatus for capturing images of a subject. More specifically, embodiments of the present invention relate to a user input interface for a handheld medical imaging apparatus.

### BACKGROUND OF THE INVENTION

Medical imaging systems are used in different applications to image different regions or areas (e.g. different organs) of patients or other objects. For example, an ultrasound imaging system may be utilized to generate an image of organs, vasculature, heart, or other portions of the body. Ultrasound imaging systems are generally located at a medical facility for example, a hospital or imaging center. The ultrasound imaging system includes an ultrasound probe placed on a portion of subject's body to capture images of objects (e.g. organs) in the subject. The images may be presented as a live streaming video of an organ to a user. These ultrasound imaging systems may have a touch based user interface that facilitates touch based user inputs for performing some operations such as button push, menu navigation, page flipping and changing image parameters. The imaging parameters may include but not limited to frequency, speckle reduction imaging, imaging angle, time gain compensation, scan depth, gain, scan format, image frame rate, field of view, focal point, scan lines per image frame, number of imaging beams and pitch of the imaging elements (for e.g. transducer elements). The user inputs can be provided using fingers or a stylus. However to perform certain operations for example measurements in an ultrasound image, user inputs provided by user's finger and stylus may be inaccurate due to human errors in positioning the finger and stylus. Further the user may be holding an ultrasound probe on patient's body to capture the images with one hand and the handheld ultrasound imaging system with the other hand. Now if any user inputs need to be given particularly for performing measurements, the user may have to free the hand holding the ultrasound probe after stopping the scanning operation which turns out to be difficult. As an alternative option the handheld ultrasonic imaging system needs to be placed on a stand so that one hand can be made free. However this may not be appropriate because the advantage of using a handheld ultrasound imaging system is not achieved.

Hence, there is a need for an improved handheld medical imaging apparatus for capturing images of objects associated with a patient in a convenient manner.

### BRIEF DESCRIPTION OF THE INVENTION

The above-mentioned shortcomings, disadvantages and problems are addressed herein which will be understood by reading and understanding the following specification.

In an embodiment a handheld ultrasound imaging apparatus for capturing images of a subject. The handheld ultrasound imaging apparatus includes a display for displaying a diagnostic ultrasound image and a plurality of user interface (UI) objects. A housing for holding the display is also provided in the handheld ultrasound imaging apparatus. Further a user input interface is configured in at least one of the display and the housing. The user input interface is operable by a user to control a pointer for providing user input at points on the display to perform one or more activities.

In another embodiment a handheld medical imaging apparatus is disclosed. The handheld medical imaging apparatus includes an image capturing unit for capturing a diagnostic image associated with an object of a subject, a display for displaying the diagnostic image and a housing holding the display. The handheld medical imaging apparatus also includes a user input interface configured in at least one of the display and the housing, the user input interface operable by a user to control a pointer for providing user input at points on the display and a control unit comprising a data processor. The control unit is configured to identify and select points on the display based on the inputs from the pointer, and perform the at least one activity in response to selection of the points.

Various other features, objects, and advantages of the invention will be made apparent to those skilled in the art from the accompanying drawings and detailed description thereof.

### BRIEF DESCRIPTION OF THE DRAWINGS

FIG. 1 illustrates a handheld ultrasound imaging system that directs ultrasound energy pulses into an object, typically a human body in accordance with an embodiment;

FIG. 2 is a schematic illustration of a handheld medical imaging apparatus 200 in accordance with an embodiment;

FIG. 3 is a schematic illustration of a display of the handheld medical imaging apparatus presenting a plurality of UI objects in accordance with an embodiment;

FIG. 4 is a schematic illustration of the display of the handheld medical imaging apparatus presenting a caliper used for performing measurements in accordance with an embodiment;

FIG. 5 is a schematic illustration of the display of the handheld medical imaging apparatus presenting sub-menu UI objects of a UI object associated with measurement in accordance with an embodiment;

FIG. 6 is a schematic illustration of the display of the handheld medical imaging apparatus presenting a caliper used for drawing an ellipse on a diagnostic ultrasound image in accordance with an embodiment;

FIG. 7 is a schematic illustration of a handheld ultrasound imaging apparatus having a touch sensitive display in accordance with an embodiment;

FIG. 8 is a schematic illustration of the handheld ultrasound imaging apparatus having the touch sensitive display showing different UI objects in accordance with an embodiment;

FIG. 9 is a schematic illustration of a handheld ultrasound imaging apparatus having a user input interface configured at a back portion of a housing in accordance with another embodiment; and

FIG. 10 is a schematic illustration of a handheld ultrasound imaging apparatus having a user input interface configured at a back portion of a housing in accordance with another embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

As discussed in detail below, embodiments of the present invention including a handheld ultrasound imaging apparatus for capturing images of a subject is disclosed. The handheld ultrasound imaging apparatus includes a display for displaying a diagnostic ultrasound image and a plurality of user interface (UI) objects. A housing for holding the display. Further a user input interface is configured in at least one of the display and the housing. The user input interface is operable by a user to control a pointer for providing user input at points on the display to perform one or more activities.

Although the various embodiments are described with respect to a handheld ultrasound imaging apparatus, the various embodiments may be utilized with any suitable a handheld medical imaging apparatus, for example, X-ray, computed tomography, or the like.

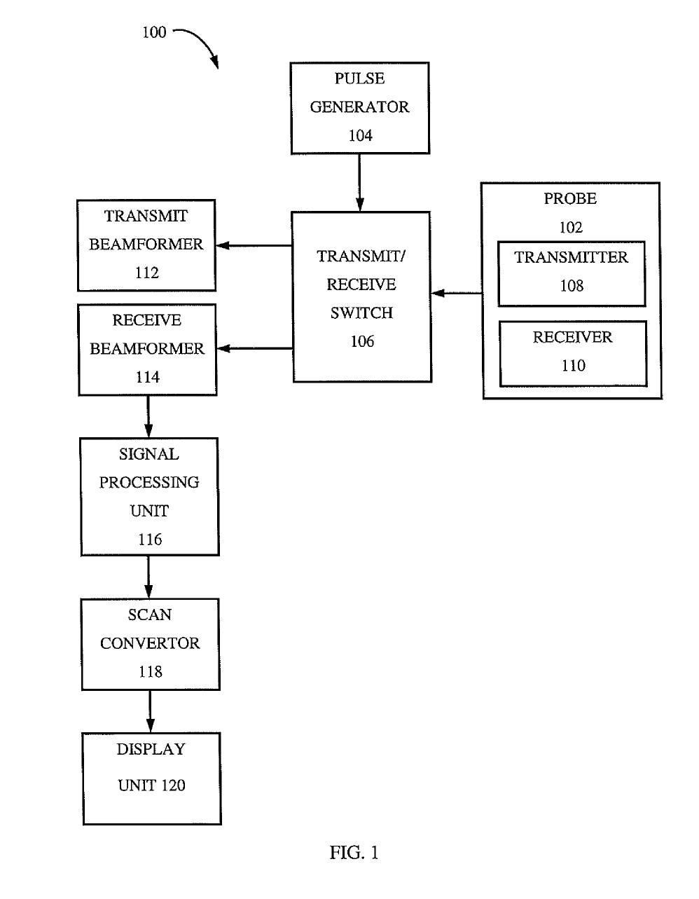

FIG. 1 shows a handheld ultrasound imaging system 100 that directs ultrasound energy pulses into an object, typically a human body, and creates an image of the body based upon the ultrasound energy reflected from the tissue and structures of the body. The ultrasound imaging system 100 may include a portable or handheld ultrasound imaging system or apparatus.

The ultrasound imaging system 100 comprises a probe 102 (i.e. an image acquisition unit) that includes a transducer array having a plurality of transducer elements. The probe 102 and the ultrasound imaging system 100 may be physically connected, such as through a cable, or they may be in communication through a wireless technique. The transducer array can be one-dimensional (1-D) or two-dimensional (2-D). A 1-D transducer array comprises a plurality of transducer elements arranged in a single dimension and a 2-D transducer array comprises a plurality of transducer elements arranged across two dimensions namely azimuthal and elevation. The number of transducer elements and the dimensions of transducer elements may be the same in the azimuthal and elevation directions or different. Further, each transducer element can be configured to function as a transmitter 108 or a receiver 110. Alternatively, each transducer element can be configured to act both as a transmitter 108 and a receiver 110.

The ultrasound imaging system 100 further comprises a pulse generator 104 and a transmit/receive switch 106. The pulse generator 104 is configured for generating and supplying excitation signals to the transmitter 108 and the receiver 110. The transmitter 108 is configured for transmitting ultrasound beams, along a plurality of transmit scan lines, in response to the excitation signals. The term “transmit scan lines” refers to spatial directions on which transmit beams are positioned at some time during an imaging operation. The receiver 110 is configured for receiving echoes of the transmitted ultrasound beams. The transmit/receive switch 106 is configured for switching transmitting and receiving operations of the probe 102.

The ultrasound imaging system 100 further comprises a transmit beamformer 112 and a receive beamformer 114. The transmit beamformer 112 is coupled through the transmit/receive (T/R) switch 106 to the probe 102. The transmit beamformer 112 receives pulse sequences from the pulse generator 104. The probe 102, energized by the transmit beamformer 112, transmits ultrasound energy into a region of interest (ROI) in a patient's body. As is known in the art, by appropriately delaying the waveforms applied to the transmitter 108 by the transmit beamformer 112, a focused ultrasound beam may be transmitted.

The probe 102 is also coupled, through the T/R switch 106, to the receive beamformer 114. The receiver 110 receives ultrasound energy from a given point within the patient's body at different times. The receiver 110 converts the received ultrasound energy to transducer signals which may be amplified, individually delayed and then accumulated by the receive beamformer 114 to provide a receive signal that represents the received ultrasound levels along a desired receive line (“transmit scan line” or “beam”). The receive signals are image data that can be processed to obtain images i.e. ultrasound images of the region of interest in the patient's body. The receive beamformer 114 may be a digital beamformer including an analog-to-digital converter for converting the transducer signals to digital values. As known in the art, the delays applied to the transducer signals may be varied during reception of ultrasound energy to effect dynamic focusing. The process of transmission and reception is repeated for multiple transmit scan lines to create an image frame for generating an image of the region of interest in the patient's body.

In an alternative system configuration, different transducer elements are employed for transmitting and receiving. In that configuration, the T/R switch 106 is not included, and the transmit beamformer 112 and the receive beamformer 114 are connected directly to the respective transmit or receive transducer elements.

The receive signals from the receive beamformer 114 are applied to a signal processing unit 116, which processes the receive signals for enhancing the image quality and may include routines such as detection, filtering, persistence and harmonic processing. The output of the signal processing unit 116 is supplied to a scan converter 118. The scan converter 118 creates a data slice from a single scan plane. The data slice is stored in a slice memory and then is passed to a display unit 120, which processes the scan converted image data so as to display an image of the region of interest in the patient's body.

In one embodiment, high resolution is obtained at each image point by coherently combining the receive signals thereby synthesizing a large aperture focused at the point. Accordingly, the ultrasound imaging system 100 acquires and stores coherent samples of receive signals associated with each receive beam and performs interpolations (weighted summations, or otherwise), and/or extrapolations and/or other computations with respect to stored coherent samples associated with distinct receive beams to synthesize new coherent samples on synthetic scan lines that are spatially distinct from the receive scan lines and/or spatially distinct from the transmit scan lines and/or both. The synthesis or combination function may be a simple summation or a weighted summation operation, but other functions may as well be used. The synthesis function includes linear or nonlinear functions and functions with real or complex, spatially invariant or variant component beam weighting coefficients. The ultrasound imaging system 100 then in one embodiment detects both acquired and synthetic coherent samples, performs a scan conversion, and displays or records the resulting ultrasound image.

In an embodiment, ultrasound data is acquired in image frames, each image frame representing a sweep of an ultrasound beam emanating from the face of the transducer array. A 1-D transducer array produces 2-D rectangular or pie-shaped sweeps, each sweep being represented by a series of data points. Each of the data points are, in effect, a value representing the intensity of an ultrasound reflection at a certain depth along a given transmit scan line. On the other hand, the 2-D transducer array allows beam steering in two dimensions as well as focus in the depth direction. This eliminates the need to physically move the probe 102 to translate focus for the capture of a volume of ultrasound data to be used to render 3-D images.

One method to generate real-time 3-D scan data sets is to perform multiple sweeps wherein each sweep is oriented in a different scan plane. In an embodiment, the transmit scan lines of every sweep are arrayed across the probe's 102 “lateral” dimension. The planes of the successive sweeps in an image frame are rotated with respect to each other, e.g. displaced in the “elevation” direction, which is, in an embodiment, orthogonal to the lateral dimension. Alternatively, successive sweeps may be rotated about a centerline of the lateral dimension. In general, each scan frame comprises plurality of transmit scan lines allowing the interrogation of a 3-D scan data set representing a scan volume of some pre-determined shape, such as a cube, a sector, frustum, or cylinder.

In one exemplary embodiment, each scan frame represents a scan volume in the shape of a sector. Therefore the scan volume comprises multiple sectors. Each sector comprises plurality of beam positions, which may be divided into sub sectors. Each sub sector may comprise equal number of beam positions. However, it is not necessary for the sub sectors to comprise equal number of beam positions. Further, each sub sector comprises at least one set of beam positions and each beam position in a set of beam positions is numbered in sequence. Therefore, each sector comprises multiple sets of beam positions indexed sequentially on a predetermined rotation.

Plurality of transmit beam sets are generated from each sector. Further, each transmit beam set comprises one or more simultaneous transmit beams depending on the capabilities of the ultrasound imaging system 100. The term “simultaneous transmit beams” refers to transmit beams that are part of the same transmit event and that are in flight in overlapping time periods. Simultaneous transmit beams do not have to begin precisely at the same instant or to terminate precisely at the same instant. Similarly, simultaneous receive beams are receive beams that are acquired from the same transmit event, whether or not they start or stop at precisely the same instant.

The transmit beams in each transmit beam set are separated by the plurality of transmit scan lines wherein each transmit scan line is associated with a single beam position. Thus, the multiple transmit beams are arranged in space separated such that they do not have significant interference effects.

The transmit beamformer 112 can be configured for generating each transmit beam set from beam positions having the same index value. Thus, beam positions with matching index value, in each sub sector, can be used for generating multiple simultaneous transmit beams that form a single transmit beam set. In one embodiment, at least two consecutive transmit beam sets are generated from beam positions not indexed sequentially. In an alternative embodiment, at least a first transmit beam set and a last transmit beam set, in a sector, are not generated from neighboring beam positions.

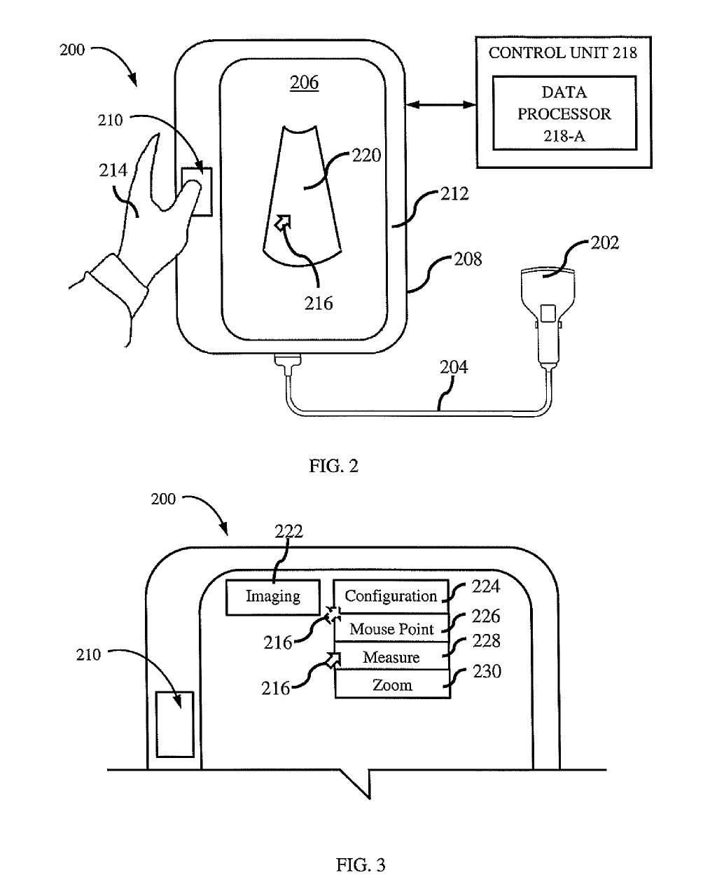

FIG. 2 is a schematic illustration of a handheld medical imaging apparatus 200 in accordance with an embodiment. The handheld medical imaging apparatus 200 may be an ultrasound imaging apparatus. FIG. 2 is described hereinafter as the handheld ultrasound imaging apparatus 200 however the functions and components of this apparatus can be applicable to other handheld medical imaging apparatuses as well without departing from scope of this disclosure. The handheld ultrasound imaging apparatus 200 includes an ultrasound probe 202 communicably connected at a port (not shown in FIG. 2) using a connecting cord 204. However it may be envisioned that an ultrasound probe may be connected to the handheld ultrasound imaging apparatus 200 using a wireless connection. The ultrasound probe 202 is used to send ultrasonic signals to a portion of the patient's body to acquire diagnostic ultrasound images. The diagnostic ultrasound images are displayed in a display 206. The diagnostic ultrasound images (i.e. image frames) are part of a live image video. The display 206 is held by a housing 208. A user input interface may be provided in one or more of a display and a housing of a handheld imaging apparatus. A user input interface may be but not limited to a touch pad, a pointing stick, a track pad and a virtual user input interface. As shown in FIG. 2 a user input interface 210 is provided in the housing 208 in accordance with an embodiment. The user input interface 210 is configured at a front portion 212 of the housing 208 outside the display 206. A user can hold the handheld ultrasound imaging apparatus 200 with a hand 214 and place a thump on the user input interface 210 to control a pointer 216 (i.e. a cursor) for providing user input at points on the display 206. The pointer 216 may be visible only when the thump is positioned on the user input interface 210. The thump can be moved on the user input interface 210 to accurately identify a point where user inputs need to be given. A control unit 218 including a data processor 218-A may be configured to detect movements or gestures of the thump on the user input interface 210. Consequently the control unit 218 identifies the point and performs one or more activities at the point. An activity performed may be for instance selection of the point based on the user input. Here the user input is for example the gesture performed using the thump for selecting a point. The gesture may be a single click or a double click on the user input interface 210. However it may be envisioned that other kinds of gestures such as a long click, a multi-touch, a flick and the like may be used for selecting the point on the display 206. The activity resulting from the gesture as discussed earlier is selection of the point. Considering an example the user can move the thump on the user input interface 210 to select or indicate a point on an ultrasound image 220. The pointer 216 can assist the user in indicating and selection of the point with reduced human errors. The ultrasound image 220 is an image frame of the live image video that is freezed by the user. The user may provide some gestures in the user input interface 210 for freezing the image frame. Further the image frame can be un-freezed in response to providing gestures in the user input interface 210.

The user can also perform gestures on the user input interface 210 to select a plurality of user interface (UI) objects. In an embodiment one or more UI objects such as an imaging object 222 and a configuration object 224 may be visible when the pointer 216 is moved closer to an upper portion of the user input interface 210. In another embodiment the user may perform some gesture using the thump on the user input interface 210 to invoke the one or more UI objects to be presented. The gesture may be for example placing the pointer 216 at the upper portion for a predefined time period. The imaging object 222 and the configuration object 224 may be part of a menu. The user can utilize the pointer 216 to select any UI object from the menu to modify any functionalities and configurations in the handheld ultrasound imaging apparatus 200. The imaging object 222 may be used for selecting an imaging type associated with an imaging to be performed by the handheld ultrasound imaging apparatus 200. The imaging type includes for example obstetric imaging, abdominal imaging and cardiac imaging. When the pointer 216 is positioned on the configuration object 224 and a gesture such as a click is performed on the user input interface 210, the control unit 218 performs an activity i.e. activating the configuration object 224. The configuration object 224 expands to present multiple configurations to the user. In another scenario the multiple configurations associated with the configuration object 224 may be presented in a separate window. The configurations may include for example, mouse point 226, measure 228, and zoom 230. The configurations shown in FIG. 3 are merely exemplary and thus other configurations such as but not limited to frequency, depth, dynamic range, freeze/unfreeze image frames and mode change (e.g. live mode, cine mode and review mode) may be presented as part of a configuration object such as the configuration object 224 without departing from the scope of this disclosure.

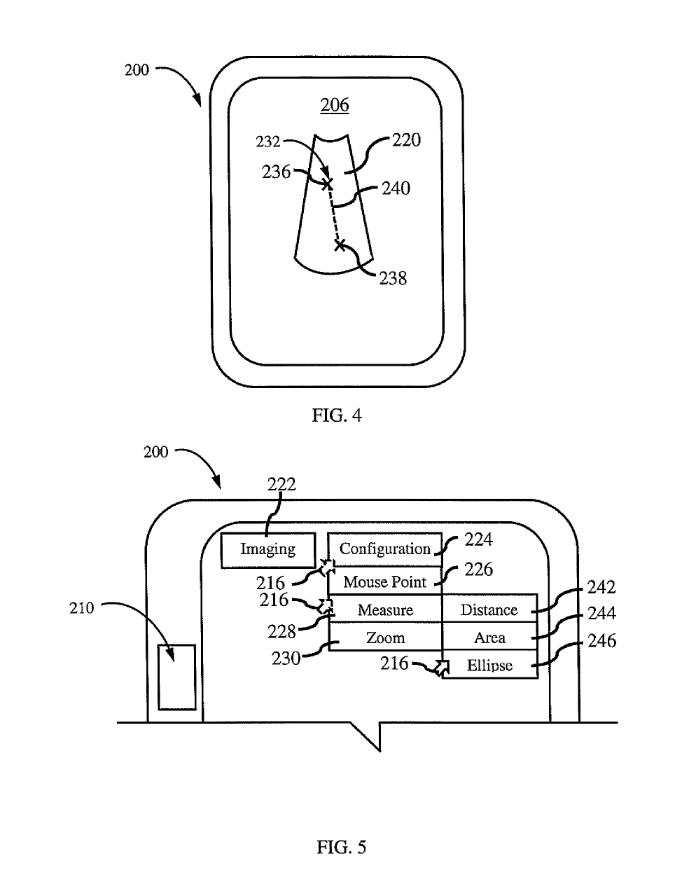

The user may move the pointer 216 to the mouse point 226 and select this UI object. The pointer 216 is then configured as a mouse used for all operations performed usually by a mouse such as navigating through multiple windows, clicking and selecting UI objects and so on. The pointer 216 can be used to select an UI object i.e. the measure 228 by a gesture (i.e. moving and clicking the thump on the user input interface 210). Once selected the pointer 216 is set or configured as a caliper for measurement which is again an activity. A caliper 232 for distance measurement is illustrated in FIG. 4 in accordance with an embodiment. Further a UI object associated with distance measurement is shown in FIG. 5. The user can perform a gesture on the user input interface 210 such as moving and identifying a first point 236 on a diagnostic ultrasound image 234. The control unit 218 registers and/or stores the first point 236. The user can select a second point 238 to measure a distance between these two points. The control unit 218 may be configured to measure and present the distance to the user through the display 206. A line 240 may be drawn joining the first point 236 and the second point 238. The line 240 may be an imaginary line. For example in the case of an image of a fetus, femur diaphysis length (FDL) may be measured using the caliper 232 by selecting two points on the fetus. To perform other measurements e.g. biparietal diameter (BPD), head circumference (HC), and abdominal circumference (AC) other types of caliper may be used. To configure the pointer 216 or the caliper 232 into another caliper the user may perform a gesture on the user input interface 210. The gesture such as a single long click may be performed on the measure 228 so that a sub-menu of UI objects may be presented and they include for example distance, area, volume, distance ratio, area ratio, ellipse, circle and angle. The sub-menu UI objects represent different types of measurements. Calipers associated with each of these UI objects may vary i.e. more specifically each caliper is associated with a type of measurement. Thus a plurality of calipers used for performing different types of measurements may be stored in a memory of the handheld medical imaging apparatus 200. The caliper 232 is selected from the plurality of calipers. Further a pointer (such as the pointer 216) may also vary based on a configuration in the handheld ultrasound imaging apparatus 200. For instance the pointer 216 is configured as the mouse when the mouse point 226 is selected and the pointer 216 may be configured as a type of cursor used for setting a desired depth upon selecting a depth configuration.

In yet another embodiment if the configuration of the medical imaging apparatus 200 is set as freeze, then the pointer 216 is automatically configured for performing measurements in the ultrasound image 220. Whereas when the medical imaging apparatus 200 is in a live mode, the pointer 216 is automatically configured for modifying imaging parameters. The imaging parameters may include but not limited to frequency, speckle reduction imaging, imaging angle, time gain compensation, scan depth, gain, scan format, image frame rate, field of view, focal point, scan lines per image frame, number of imaging beams and pitch of the imaging elements (for e.g. transducer elements). The imaging parameters vary based on imaging procedures. The imaging procedures include for example, abdominal imaging, cardiac imaging, obstetric imaging, fetal imaging, and renal imaging. Now in case the configuration set for the medical imaging apparatus 200 is a cine/review mode then the pointer 216 is configured for performing activities such as moving image frames and run and/or stop operations when the image frames are being displayed. The run and stop operations may be performed for displaying the image frames one after the other and pausing at on image frame respectively. These settings for the described configurations can be preset in the medical imaging apparatus 200 by the user. For instance the settings can be made in a utility configuration section of the medical imaging apparatus 200 before commencing an imaging operation or procedure.

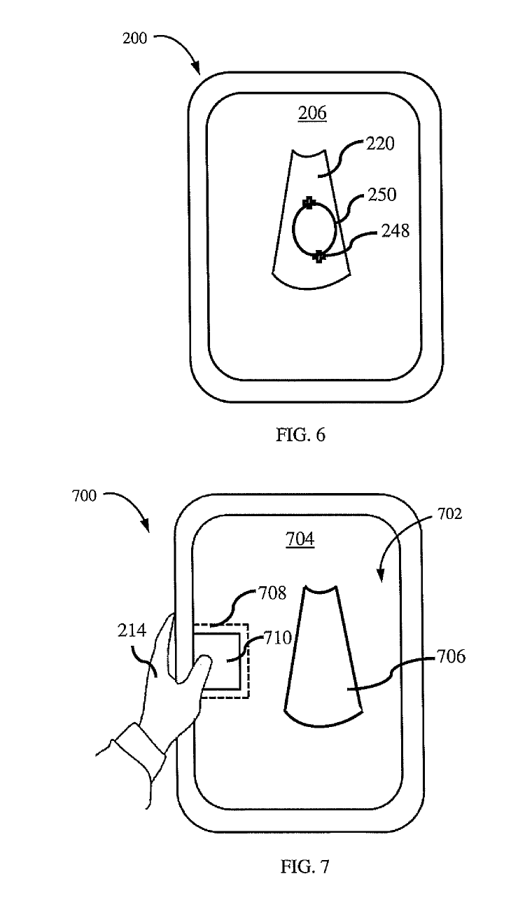

FIG. 5 illustrates the display 206 presenting sub-menu UI objects of the measure 228 in accordance with an embodiment. As illustrated in FIG. 5 the pointer 216 is used to perform the gesture i.e. a single long click so that the sub-menu UI objects of the measure 228 are presented. These UI objects include distance 242, area 244 and ellipse 246. The pointer 216 can be used to select the ellipse 246 resulting in configuring the pointer 216 as a caliper 248 for drawing an ellipse 250 as shown in FIG. 6. In an embodiment when the caliper 232 needs to be configured as the caliper 248, the user may need to initially configure the caliper 232 as the pointer 216 i.e. a mouse by selecting the mouse point 226 and thereafter configured as the caliper 248. In another embodiment the user may perform an operation on the user input interface 210 to directly convert the caliper 232 into the pointer 216 (i.e. mouse). In this embodiment a portion of the user input interface 210 may be configured to convert any current caliper of the plurality of calipers into the pointer 216 in response to a gesture (i.e. a click) on this portion by the user's thump. In yet another embodiment a portion of the user input interface 210 may be configured for presenting the sub-menu of UI objects of the measure 228 in response to a gesture (i.e. click) on the portion. Then user's thump can be used to directly select an UI object associated with a desired measurement type to configure a caliper of the desired measurement type. Now referring back to the caliper 248 shown in FIG. 6, the caliper 248 is used by the user for selecting a first point 252 and a second point 254 so that the ellipse 250 is drawn by the control unit 218. The ellipse 250 may be drawn automatically or manually by the user. The ellipse 250 is drawn to perform measurements such as a head circumference (HC) and an abdominal circumference (AC) in the diagnostic ultrasound image 234. Similarly different calipers may be used by the user to perform different measurements in a diagnostic ultrasound image.

The pointer 216 used for performing different activities may be hidden when the user does not operate the user input interface 210 for a predefined time period. In this instance the user's thump may not be on the user input interface 210. Hiding the pointer 216 avoids any distraction to the user viewing diagnostic ultrasound images presented live in the user input interface 210.

FIG. 7 is a schematic illustration of a handheld ultrasound imaging apparatus 700 having a touch sensitive display 702 in accordance with an embodiment. The touch sensitive display 702 has a first region 704 presenting a diagnostic ultrasound image 706, and a second region 708 outside the first region 704. The second region 708 is configured as a user input interface 710. In an embodiment the second region 708 may have an area larger than an area of the user input interface 710. In another scenario the area of the second region 708 and the user input interface 710 may be the same. In an embodiment the user input interface 710 may be presented when a user touches the second region 708. As illustrated in FIG. 7 the user uses a thump to operate the user input interface 710. In a scenario the user may perform a gesture so that the user input interface 710 is presented. The gesture may be for example but not limited to sliding the thump on the second region 708, clicking on the second region 708, touching the second region 708 for a predefined time. In another instance the user input interface 710 may be presented when the user's thump come in contact with any portion of the display 702.

The user input interface 710 may be used by the user to perform different activities in the handheld ultrasound imaging apparatus 700 for capturing the diagnostic ultrasound image 706 and working on the image similar to the user input interface 210. Thus all functions performed using the user input interface 210 described in conjunction with FIGS. 2-6 can be performed using the user input interface 710. Hence the functions performed using the user input interface 710 are not described in detail with respect to FIG. 7.

The user input interface 710 is used to control a pointer (i.e. a cursor) for providing user input at points on the display 702. The user inputs are provided by placing the user's thump on the user input interface 710. The pointer may be visible only when the thump is positioned on the user input interface 710. The thump can be moved on the user input interface 710 to accurately identify a point where the user inputs need to be given. The point may be identified upon detecting movements or gestures of the thump on the user input interface 710. Thereafter one or more activities are performed at the point. An activity performed may be for instance selection of the point based on the user input. Here the user input is for example the gesture performed using the thump for selecting a point. The gesture may be a single click or a double click on the user input interface 710.

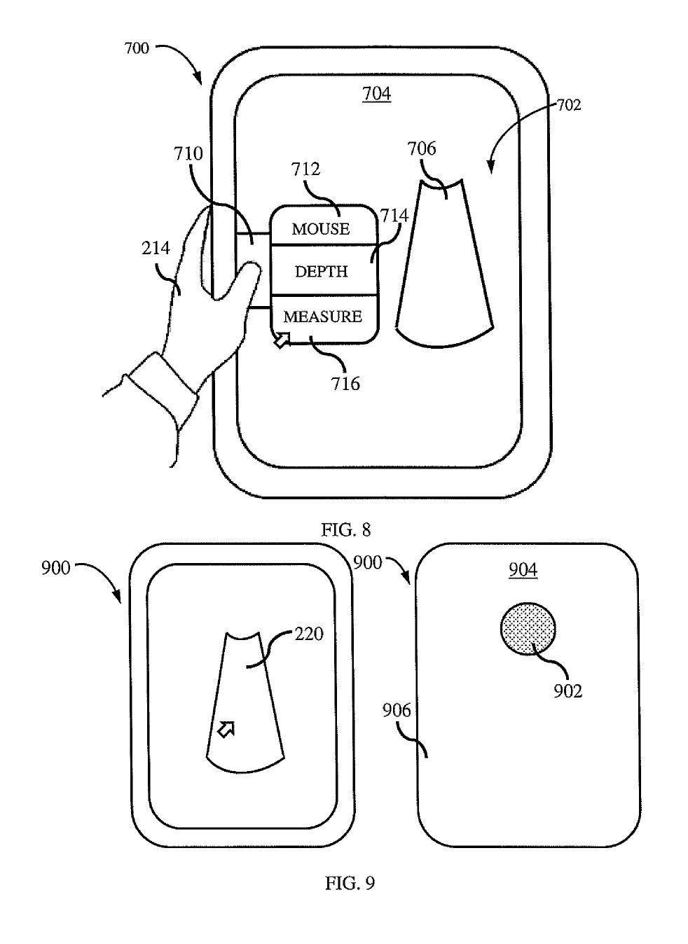

The user can also perform gestures on the user input interface 710 to select the plurality of user interface (UI) objects. The user can utilize the pointer to modify any configuration in the handheld ultrasound imaging apparatus 700. In an embodiment the pointer may be positioned on the user input interface 710 and a gesture may be provided. Once the gesture is detected then a plurality of configurations may be presented in the display 702. The gesture may be for example a single long click on the user input interface 710. However it may be envisioned that other gestures such as multi-touch, flick, a double tap and the like may be performed for invoking the display of the configurations. The configurations may be shown as different UI objects and they may include for example, mouse 712, depth 714, and measure 716 as illustrated in FIG. 8. A desired configuration may be selected by touching a corresponding UI object using the user's thump. The configurations shown in FIG. 7 and FIG. 8 are merely exemplary and thus other configurations such as but not limited to frequency, dynamic range, freeze/unfreeze image frames and mode change may be presented without departing from the scope of this disclosure. The pointer may vary based on a configuration. For instance the pointer is configured as the mouse when the mouse 712 is selected and the pointer may be configured as a type of cursor used for setting a depth upon selecting the depth 714.

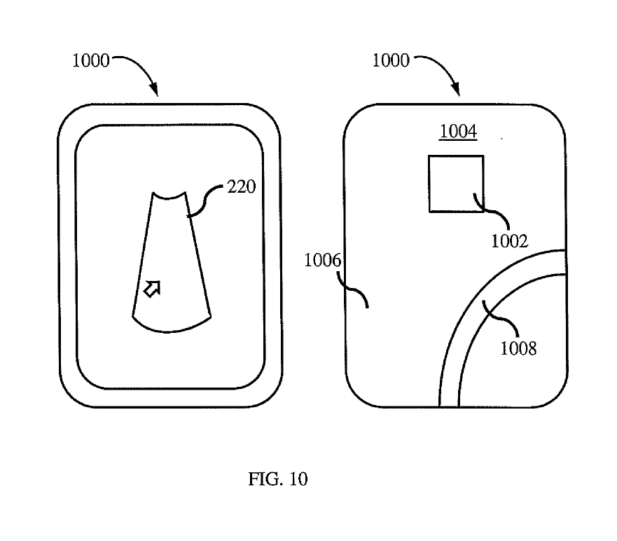

A user input interface such as the user input interface 210 and the user input interface 710 may configured in other locations of a housing of a handheld ultrasound imaging apparatus. FIG. 10 illustrates a handheld ultrasound imaging apparatus 1000 having a user input interface 1002 configured at a back portion 1004 of a housing 1006 in accordance with another embodiment. Here the user input interface 1002 is a pointing stick. The user can use any of user's fingers to control the user input interface 1002 while holding the handheld ultrasound imaging apparatus 1000. Further FIG. 10 illustrates a handheld ultrasound imaging apparatus 1000 having a user input interface 1002 configured at a back portion 1004 of a housing 1006 in accordance with another embodiment. In this case the user input interface 1002 is a touch pad. The handheld ultrasound imaging apparatus 1000 may also include a hand holder 1008 that can assist the user to hold the handheld ultrasound imaging apparatus 1000 securely. The user's hand can be inserted between the hand holder 1008 and the back portion 1004 so that handheld ultrasound imaging apparatus 1000 can be held with a firm grip and in a convenient manner. The hand holder 1008 also prevents the handheld ultrasound imaging apparatus 1000 from slipping and falling from the hand. Even though the hand holder 1008 is shown as part of the handheld ultrasound imaging apparatus 1000, similar hand holders may be present in the handheld ultrasound imaging apparatuses 200, 700, 900 and 1000. Further the configuration or structure of the hand holder 1008 as shown in FIG. 10 is exemplary and hence any other hand holder with a different configuration or structure may be provided on a housing of the handheld ultrasound imaging apparatus for securely holding the handheld ultrasound imaging apparatus without departing from the scope of this disclosure.

The methods and functions can be performed in the handheld ultrasound imaging apparatus (such as a handheld ultrasound imaging apparatuses 200, 700, 900 and 1000) using a processor or any other processing device. The method steps can be implemented using coded instructions (e.g., computer readable instructions) stored on a tangible computer readable medium. The tangible computer readable medium may be for example a flash memory, a read-only memory (ROM), a random access memory (RAM), any other computer readable storage medium and any storage media. Although these methods and/or functions performed by the handheld ultrasound imaging apparatus in accordance with another embodiment are explained with reference to the FIGS. 2 to 10, other methods of implementing the functions can be employed. For example, the order of execution of each method steps or functions may be changed, and/or some of the method steps described may be changed, eliminated, divide or combined. Further the method steps and functions may be sequentially or simultaneously executed by a handheld ultrasound imaging apparatus in accordance with another embodiment.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A handheld electronic apparatus comprising:
a housing comprising a front portion and a back portion;
a display configured at the front portion of the housing; and
a user input interface configured at the back portion of the housing, wherein the user input interface is configured to receive a user input controlling a position of a pointer on the display.

2. The handheld electronic apparatus of claim 1, wherein the user input interface comprises one of a track pad, a touch pad, and a pointing stick.

3. The handheld electronic apparatus of claim 1, further comprising a control unit comprising a data processor, wherein the control unit is configured to identify a point on the display based on a position of the pointer on the display.

4. The handheld electronic apparatus of claim 1, wherein the user input is provided as at least one gesture.

5. The handheld electronic apparatus of claim 4, wherein the control unit is further configured to select an image configuration from a plurality of image configurations in response to detecting the at least one gesture.

6. The handheld electronic apparatus of claim 4, wherein the control unit is further configured to set the pointer as a caliper of measurement in response to detecting the at least one gesture.

7. The handheld electronic apparatus of claim 1, further comprising a second user input interface configured at a front portion of the housing.

8. The handheld electronic apparatus of claim 7, wherein the display is a touch sensitive display and at least a portion of the touch sensitive display is configured as the second user input interface.

9. The handheld electronic apparatus of claim 7, wherein the second user input interface comprises one of a track pad, a touch pad, and a pointing stick.

10. The handheld electronic apparatus of claim 3, wherein the control unit is configured to display the pointer when a user touches the user input interface, and wherein the control unit is configured to hide the pointer after a predetermined amount of time from the last user contact with the user input interface.

11. The handheld electronic apparatus of claim 1, further comprising a hand holder disposed on the back portion of the housing, wherein the hand holder is adapted to receive at least a portion of a user's hand.

12. A handheld medical imaging apparatus comprising:
a display for displaying the diagnostic image;
a housing comprising a front portion and a back portion, wherein the front portion is configured to receive the display; and
a user input interface disposed on the back portion of the housing, wherein the user input interface is configured to receive a user input controlling a position of a pointer on the display.

13. The handheld medical imaging apparatus of claim 12, wherein the handheld medical imaging apparatus comprises a handheld ultrasound imaging device.

14. The handheld medical imaging apparatus of claim 12, further comprising a control unit comprising a data processor, wherein the control unit is configured to identify and select a point on the display based on a position of the pointer on the display

15. The handheld medical imaging apparatus of claim 14, wherein the control unit is configured to perform at least one activity in response to the selected point on the display.

16. The handheld medical imaging apparatus of claim 15, wherein the control unit is configured to set the pointer as a caliper of measurement in response to detecting a gesture through the user input interface.

17. The handheld medical imaging apparatus of claim 12, wherein the housing is generally rectangular in shape.

18. The handheld medical imaging apparatus of claim 14, wherein the control unit is configured to select an imaging configuration in response to detecting a gesture inputted through the user input interface.

19. The handheld medical imaging apparatus of claim 12, further comprising a hand holder disposed on the back portion of the housing, wherein the hand holder is adapted to receive at least a portion of a user's hand.

20. The handheld medical imaging apparatus of claim 14, wherein the control unit is configured to display the pointer when a user touches the user input interface.
